(19) United States
(12) Patent Application Publication
(10) Pub. No.: US 2011/0262013 A1
(43) Pub. Date: Oct. 27, 2011

(54) FINGERPRINT MATCHER USING ITERATIVE PROCESS AND RELATED METHODS

(75) Inventors: Mark Rahmes, Melbourne, FL (US); David Lyle, Manassas, VA (US); Josef Allen, Melbourne, FL (US); Michael McGonagle, Melbourne, FL (US)

(73) Assignee: Harris Corporation, Melbourne, FL (US)

(21) Appl. No.: 12/764,729

(22) Filed: Apr. 21, 2010

(51) Int. Cl. G06K 9/62

(52) U.S. Cl. 382/125

(57) ABSTRACT

A method may be for operating a fingerprint matcher receiving reference fingerprint data. The fingerprint matcher may include a memory and a controller cooperating therewith. The method may include determining ridge flow direction magnitude values for each block of input fingerprint data using the memory and controller, and iteratively identifying blocks of the input fingerprint data in which the respective ridge flow direction magnitude values exceed an iteratively decremented threshold until reaching a stopping point thereby defining a final set of identified blocks of the input fingerprint data using the memory and controller. The method may also include determining a match between the reference fingerprint data and the final set of identified blocks of the input fingerprint data using the memory and controller.

### FIELD OF THE INVENTION

The present invention relates to the field of biometric matching, and, more particularly, to fingerprint image data matching and related methods.

### BACKGROUND OF THE INVENTION

Biometric identification is a robust and reliable way to identify a person. The typical benefits of biometric identification are that each and every person has the needed biometric characteristics to be identified and that those biometric characteristics are unique to each individual. There are several typical biometric characteristics that are used for identification purposes, for example, fingerprints, retinal scans, and voiceprints.

Fingerprint biometric scanners have enjoyed substantial commercial success. These scanners have been implemented in commonplace security and access applications, for example, for providing access to buildings and sections therein, and electronic devices, such as cell phones and laptop computers.

Given the utility of fingerprint biometrics in identifying people, the use of fingerprint biometrics has naturally found great acceptance in the forensic sciences. Indeed, many law enforcement agencies maintain large databases of fingerprint biometrics from criminals and certain civilians. Accordingly, if a fingerprint is found in connection with an investigation, the investigating agency may query their database with the fingerprint in an attempt to match the fingerprint with one stored in the database, thereby determining the identity of the person who left the fingerprint.

Of course, this aforementioned matching process typically works best when the input fingerprint is clean and detailed, thereby depicting accurately the common fingerprint patterns. Nevertheless, in practice, for whatever reasons, the typical found fingerprint is a latent fingerprint, which is typically accidentally left by the person. In other words, the latent fingerprint typically may include only a small portion of the surface of the finger. Furthermore, the latent fingerprint may include distortions, for example, smudges. Therefore, it may be advantageous to process and clean up the latent fingerprint before submitting it for matching to a database.

An approach to pre-processing the latent fingerprint may be to apply a directional filter operation to the latent fingerprint. The directional filter operation may break the latent fingerprint down into blocks and categorize each block based upon whether the direction of the ridges flow can be determined and the strength of such a determination. During this pre-processing, the user may manually apply a threshold operation in an ad hoc manner that removes any blocks not having a threshold direction magnitude. The user may adjust the threshold direction magnitude and review the processed latent fingerprint image to determine whether it satisfactory for submission for matching to the database. A potential drawback to this approach is the intensive user input in the pre-processing, which may make pre-processing a large number of latent fingerprints onerous.

Another approach is disclosed in U.S. Patent Application Publication No. 2006/0147096 to Lee et al. Lee et al. discloses a fingerprint image filtering method including applying a directional filter to the input fingerprint image, and normalizing the directional fingerprint image. The method also includes dividing the normalized directional fingerprint image into blocks and classifying each one of the blocks as background and foreground image data.

Another approach is disclosed in U.S. Patent Application Publication No. 2007/0047783 to Kim et al. Kim et al. discloses a method for processing a fingerprint image including extracting a fingerprint region from the fingerprint image, and extracting ridge direction from the fingerprint region.

### SUMMARY OF THE INVENTION

In view of the foregoing background, it is therefore an object of the present invention to provide a fingerprint matcher that readily processes latent fingerprints.

This and other objects, features, and advantages in accordance with the present invention are provided by a fingerprint matcher comprising a memory configured to store reference fingerprint data, and a controller cooperating with the memory. The controller is configured to determine ridge flow direction magnitude values for each block of a plurality of blocks of input fingerprint data, and iteratively identify blocks of the input fingerprint data in which the respective ridge flow direction magnitude values exceed an iteratively decremented threshold until reaching a stopping point thereby defining a final set of identified blocks of the input fingerprint data. The controller is configured to determine a match between the reference fingerprint data and the final set of identified blocks of the input fingerprint data. Advantageously, the fingerprint matcher may process and match latent fingerprints, even of low quality, automatically without intervention of the user.

In particular, the controller is configured to iteratively determine a potential stopping point value based upon a perimeter of a given set of identified blocks of the fingerprint input data and an area thereof. The controller is configured to determine the stopping point based upon an increase in the iteratively determined potential stopping point values. For example, in some embodiments, the given set of identified blocks of the fingerprint input data may be contiguous. More specifically, the controller is configured to iteratively determine the potential stopping point value based upon a square of the perimeter of the given set of identified blocks of the input fingerprint data divided by the area thereof.

In other embodiments, the controller is configured to binarize the input fingerprint data. For example, each of the plurality of blocks may comprise a 16-pixel by 16-pixel block.

Another aspect is directed to a method of operating a fingerprint matcher receiving reference fingerprint data. The fingerprint matcher may include a memory and a controller cooperating therewith. The method includes determining ridge flow direction magnitude values for each block of a plurality of blocks of input fingerprint data using the memory and controller, and iteratively identifying blocks of the input fingerprint data in which the respective ridge flow direction magnitude values exceed an iteratively decremented threshold until reaching a stopping point thereby defining a final set of identified blocks of the input fingerprint data using the memory and controller. The method also includes determining a match between the reference fingerprint data and the final set of identified blocks of the input fingerprint data using the memory and controller.

### BRIEF DESCRIPTION OF THE DRAWINGS

FIG. 1 is a schematic block diagram of a fingerprint matcher, according to the present invention.

FIGS. 2a and 2b are a direction magnitude diagram and a corresponding ridge flow pattern diagram, respectively, from the fingerprint matcher of FIG. 1.

FIG. 3 is a flowchart illustrating operation of the fingerprint matcher of FIG. 1.

FIGS. 4a-4c are, during a first iteration in the fingerprint matcher of FIG. 1, a latent fingerprint for processing, a blur map of the processed latent fingerprint, and a ridge flow diagram corresponding to the processed latent fingerprint, respectively.

FIGS. 5a-5c are, during a second iteration in the fingerprint matcher of FIG. 1, a latent fingerprint for processing, a blur map of the processed latent fingerprint, and a ridge flow diagram corresponding to the processed latent fingerprint, respectively.

FIGS. 6a-6c are, during a third iteration in the fingerprint matcher of FIG. 1, a latent fingerprint for processing, a blur map of the processed latent fingerprint, and a ridge flow diagram corresponding to the processed latent fingerprint, respectively.

FIGS. 7a-7c are, during a fourth iteration in the fingerprint matcher of FIG. 1, a latent fingerprint for processing, a blur map of the processed latent fingerprint, and a ridge flow diagram corresponding to the processed latent fingerprint, respectively.

FIGS. 8a-8c are a latent fingerprint for processing, a ridge flow diagram corresponding to the processed latent fingerprint in the first iteration, and a ridge flow diagram corresponding to the processed latent fingerprint in the fourth iteration, respectively, in the fingerprint matcher of FIG. 1.

FIG. 9 is a diagram illustrating a direction finding filter bank in the fingerprint matcher of FIG. 1.

FIG. 10 is a diagram illustrating a steerable filter bank in the fingerprint matcher of FIG. 1.

FIG. 11 is a diagram illustrating another steerable filter bank in the fingerprint matcher of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

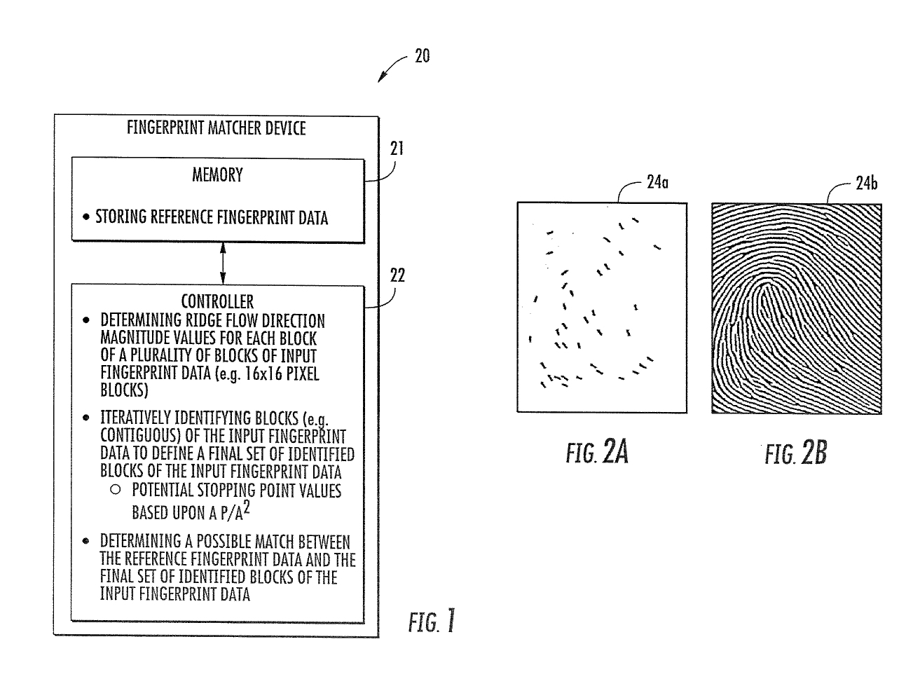

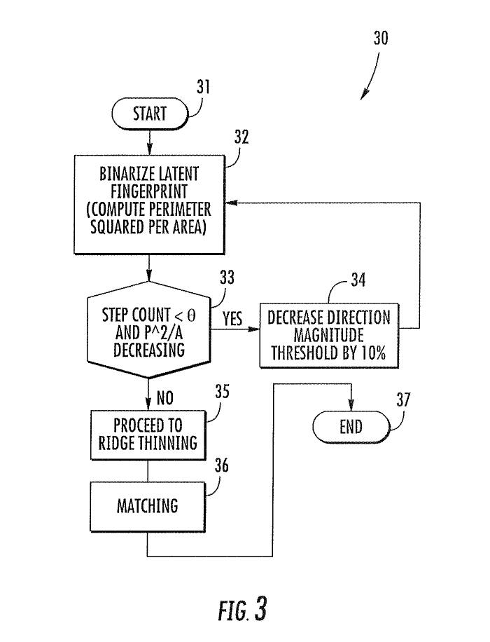

Referring initially to FIGS. 1-2b, a fingerprint matcher 20 according to the present invention is now described along with a method of operating the same with reference to a flowchart 30. The fingerprint matcher 20 includes a memory 21 configured to store reference fingerprint data, and a controller 22 cooperating with the memory. As will be appreciated by those skilled in the art, the reference fingerprint data may be retrieved from a large central database and stored in any number of formats, for example, a wavelet scalar quantization format and a Joint Photographic Experts Group 2000 format.

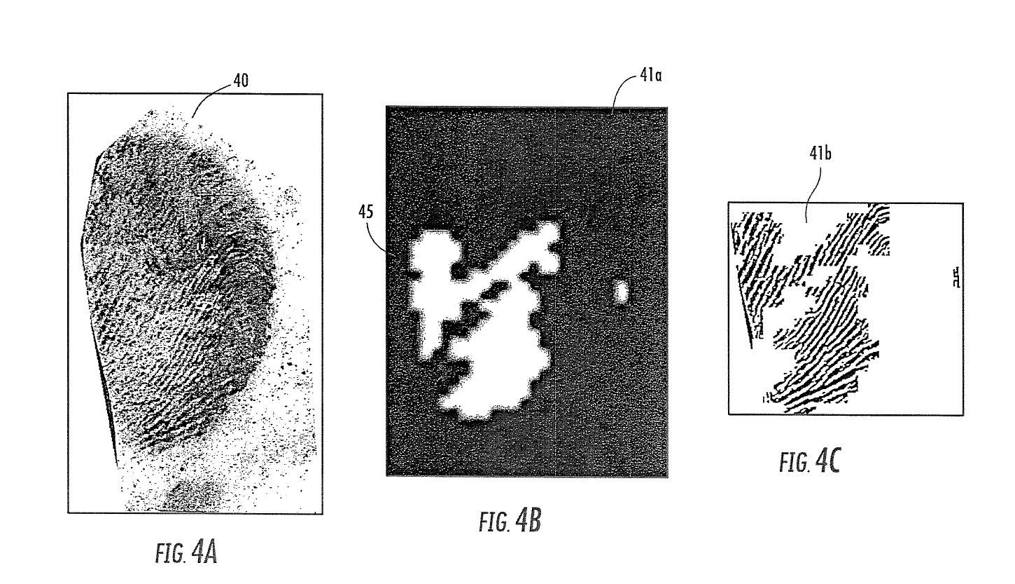

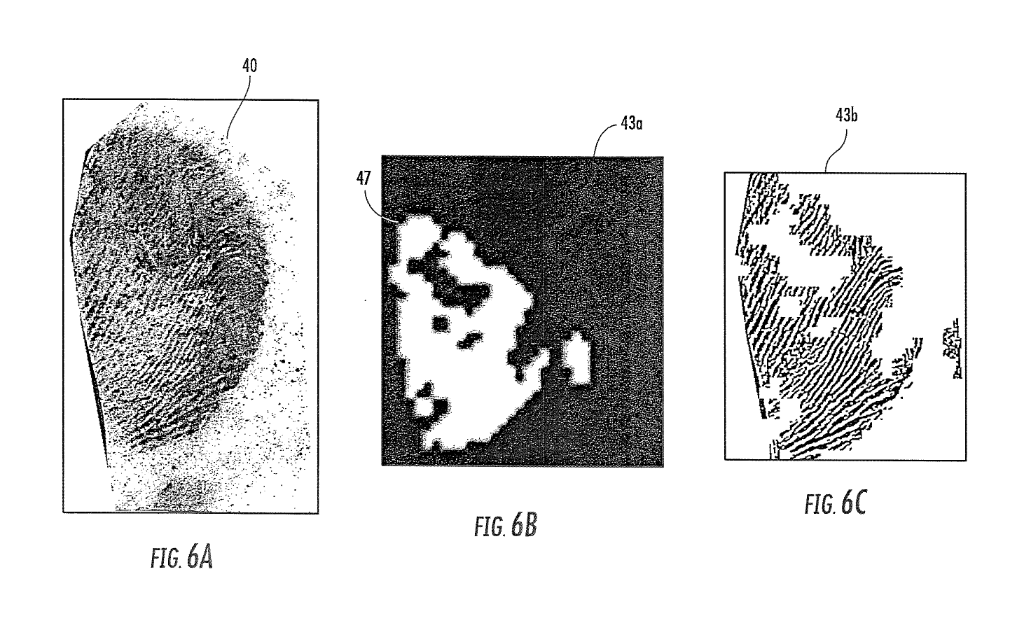

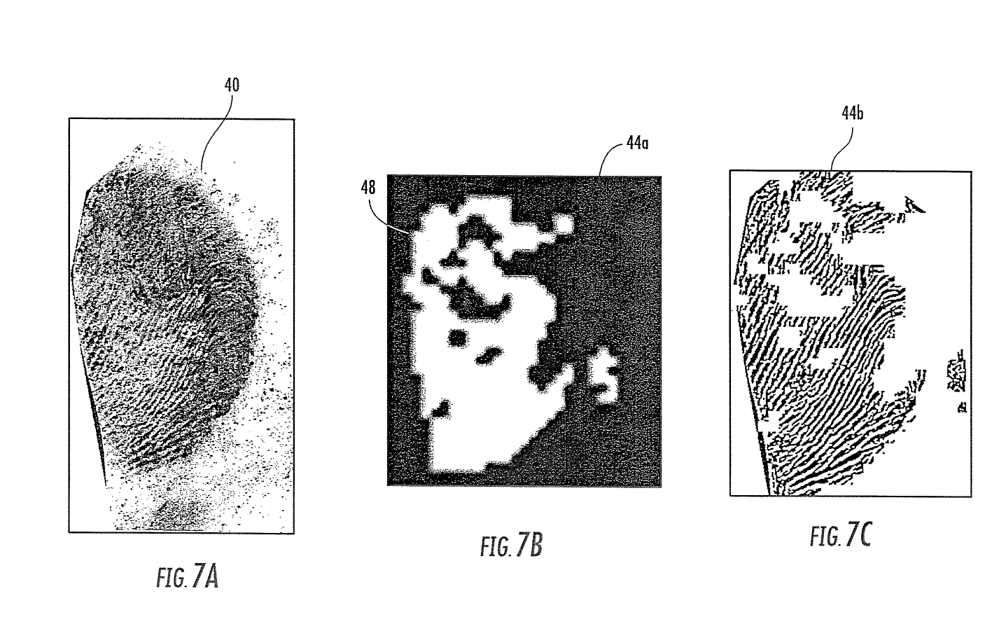

The controller 22 is configured to receive and process input fingerprint data 40 (FIGS. 4a-8c), which may comprise any of the aforementioned formats. For example, the input fingerprint data 40 may comprise a latent fingerprint image from an external source. Once latent input fingerprint data is received, the controller is configured to binarize the fingerprint data, i.e. convert the input fingerprint data into a black and white image (Blocks 31-32). In other embodiments, the binarizing process may be omitted. The controller 22 is configured to organize the input fingerprint data 40 into a plurality of blocks. For example, each block may comprise a 16-pixel by 16-pixel block.

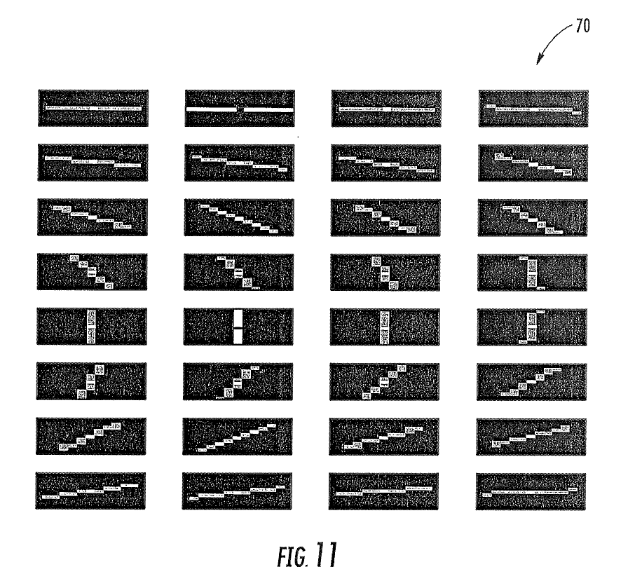

Referring briefly and additionally to FIGS. 9-11, subsequent to the segmentation of the input fingerprint data 40 into the plurality of blocks, the controller 22 is configured to determine ridge flow direction magnitude values for each block of a plurality of blocks. As shown in diagram 24a, the controller is configured to determine direction magnitude values for the corresponding ridge flow pattern 24b. To produce the ridge flow direction magnitude values, the controller 22 is configured to pass each of the blocks through a direction finding filter bank 50. Furthermore, the controller 22 is configured to pass the blocks through steerable filter banks, for example, the illustrated aligned 60 and orthogonal 70 filter banks.

As will be appreciated by those skilled in the art, the ridge direction finding filter is similar to the Hough Transform in that it finds the energy along a linear path. There are 16 different directions in the direction finding filter bank 50 that are used by the filter to evaluate ridge direction. These 16 direction slits start with the horizontal and increase in angle uniformly (including the vertical—slit 9), with slit 16 almost being back to horizontal.

Once all the ridge directions are found in the fingerprint, a ridge smoothing operation is applied to enhance ridge flow continuity such that now there are not a few discrete directions, but many possible directions with floating point precision. The filter steerable banks 60, 70 are used for deciding whether a pixel is on a ridge or valley (i.e., black or white) for binarization. This filter is aligned orthogonal to the ridge flow direction per 16×16 pixel blocks. The grayscale pixel intensities in this filter are used to make the decision on an individual pixel-by-pixel basis. If there is no strong direction found for ridge flow above a user defined threshold, then the block is labeled a “blur block” and no fingerprint minutiae are extracted from that region of the fingerprint.

Referring now additionally to FIGS. 4a-4c, once the direction magnitude values have been produced, the controller 22 is configured to perform iterative operations on the plurality of blocks from the input fingerprint data 40. In other words, the controller 22 iteratively identifies blocks of the input fingerprint data 40 in which the respective ridge flow direction magnitude values exceed an iteratively decremented threshold until reaching a stopping point thereby defining a final set of identified blocks of the input fingerprint data.

The controller 22 is configured to iteratively identify blocks of the input fingerprint data 40 in which the respective ridge flow direction magnitude values exceed a threshold value. Based upon these identified blocks, the controller 22 creates a blur map 41a of the identified blocks. The blur map 41a masks off blocks that do not satisfy the applied quality metric, in this case, a minimum direction magnitude threshold value. The controller 22 is configured to determine a largest contiguous (connected) collection of blocks 45 in the blur map 41a and determine a perimeter and area calculation for the contiguous collection of blocks. From these calculations, the controller 22 determines a dimensionless ratio of the square of the perimeter of the largest contiguous collection of blocks 45 divided by the area of the same collection of blocks (P²/A) (Block 33). The threshold process provides a corresponding ridge flow diagram 41b for the identified blocks. Of course, in other embodiments, the above calculations need not be limited only to the largest collection of contiguous blocks 45, but may include all the identified blocks.

At Block 33, if the ratio P²/A has decreased in value, the controller 22 is configured to decrement the threshold value and return to Block 32 to restart the process (Block 34), i.e. each of the ratio P²/A represents a potential stopping point. In the illustrated embodiment, the controller 22 reduces the threshold value by %10, but other values may be used. Of course, to enable finer control of the process and to determine the most efficient ratio, the decrement amount may be smaller, but this may increase the computational overhead of the process.

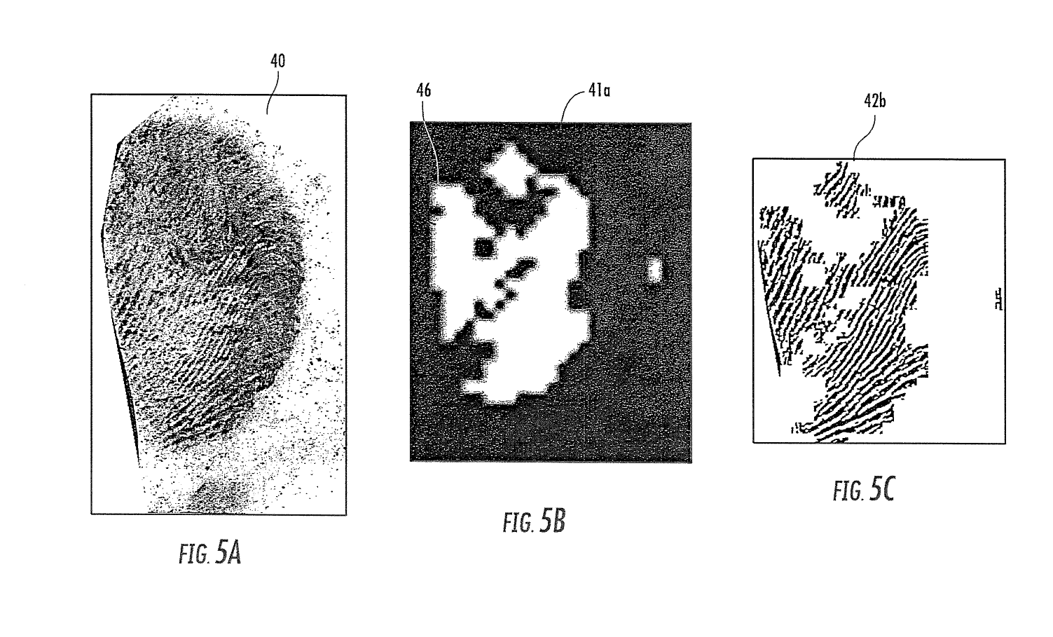

Referring now additionally to FIGS. 5a-7c, the second, third, and fourth illustrative iterations each have a corresponding contiguous collection of blocks 46-48 and blur map 42a, 43a, 44a. Of course, as the threshold value is decremented, the number of blocks that are identified in the blur map 42a, 43a, 44a grows and so does the corresponding ridge flow diagram 42b, 43a, 44b. Between the third and fourth iterations, the ratio P²/A increases in value, which is the stopping point of the iteration. In the illustrated embodiment, the iterative operation has a default stopping point of a maximum number of iterations θ.

The fourth iteration defines a ridge flow diagram 44b with a final set of identified blocks of the input fingerprint data 40. During the illustrated four iterations, the threshold value (direction magnitude value) is decreased sequentially: 38, 34, 31, and 28. The ratio P²/A has the following corresponding values during the four iterations: 52.6, 41.7, 28.8, and 32.0.

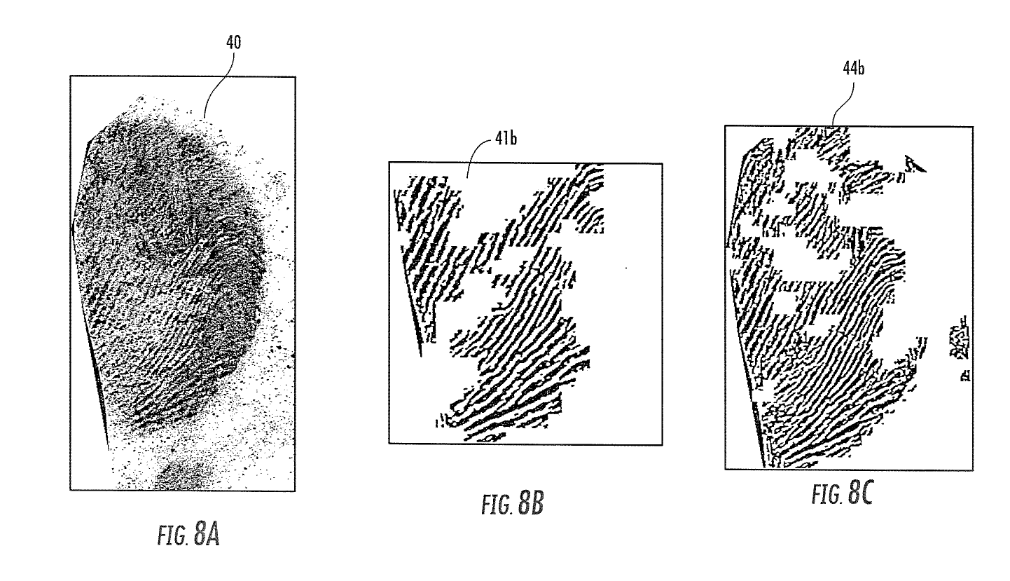

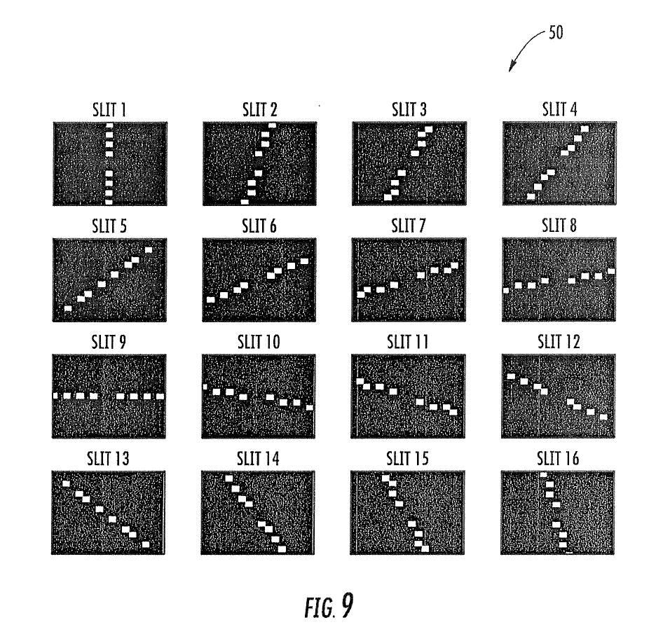

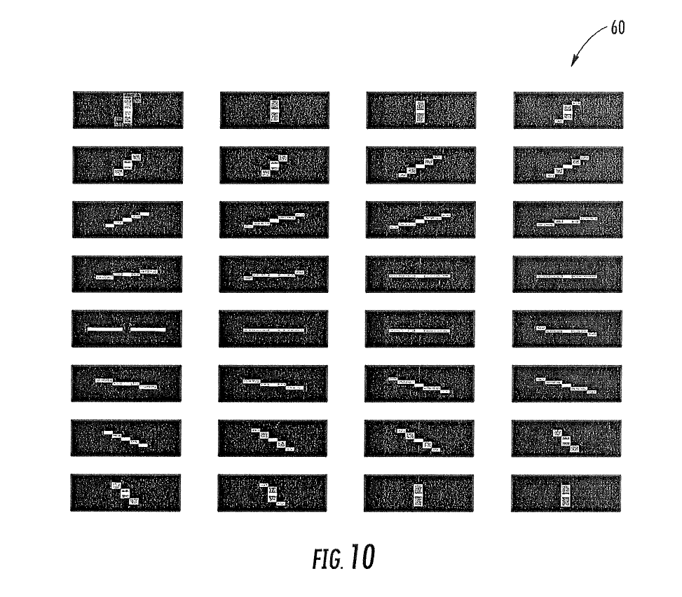

Referring now additionally to FIGS. 8a-8c, the input fingerprint data 40 is compared with the ridge flow diagrams 44b of the final set of identified blocks and the identified blocks of the first iteration 41b. As can be appreciated, the ridge flow diagram 41b of the first iteration is likely insufficient to perform a matching operation with the reference fingerprint data. Advantageously, the final ridge flow diagram 44b includes more identifying characteristics, which enable a more accurate matching process with the reference fingerprint data. In the illustrated embodiment, before proceeding to the matching process (Block 36), the controller 22 is configured to subject the final set of blocks to a ridge thinning operation at Block 35. Of course, in other embodiments, this optional ridge thinning may be omitted. The process ends at Block 37.

Advantageously, the controller 22 of fingerprint matcher 20 is configured to process and match latent input fingerprint data automatically based upon the above disclosed iterative process. Of course, the fingerprint matcher 20 can operate without user intervention, which enables the processing of large amounts of data in an efficient manner. The ratio P²/A provides the fingerprint matcher 20 with the best magnitude threshold value that filters out blocks with substantial distortion that would reduce the effectiveness of the subsequent matching process, but without being too aggressive and removing helpful ridge flow characteristics. The adjusting of the direction magnitude threshold value may help recover more print from noisy latent input fingerprint images.

As will be appreciated by those skilled in the art, an exemplary implementation of source code for calculating the direction magnitude values of the input fingerprint data is shown hereinbelow.

```
// Find the ridge flow directions in grayscale image.
// ignore the outside border of the image
for(yb=1;yb< (info−>yBlocks−2) ;yb++)
{
doYield(hWnd);
for (xb=1;xb< (info−>xBlocks−1);xb++)
{
if( ( ( yb <= ( info−>yBlocks − middle ) )
&& ( yb >= middle )
&& ( xb <=( info−>xBlocks − middle ) )
&& ( xb >= middle ) )
|| info−>binarizeMagnitude[yb] [xb] > 0 )
{
// Initialize variable sums to 0.
sinDirection = 0;
cosDirection = 0;
sumDelta = 0;
// Now start processing the pixels in the block.
for (j=yb*blockSize, uly=j+blockSize;j<uly;j++)
{
register int i;
a = greyImage [j−8] ;
b = greyImage [j−7] ;
c = greyImage [j−6] ;
d = greyImage [j−5] ;
e = greyImage [j−4] ;
f = greyImage [j−3] ;
g = greyImage [j−2] ;
h = greyImage [j−1] ;
r = greyImage [j] ;
// ‘r’ points to the current ROW under study
s = greyImage [j+1] ;
t = greyImage [j+2] ;
u = greyImage [j+3] ;
v = greyImage [j+4] ;
w = greyImage [j+5] ;
x = greyImage [j+6] ;
y = greyImage [j+7] ;
z = greyImage [j+8] ;
for (i=xb*blockSize, ulx=i+blockSize; i<ulx; i++)
{
int slitMin;
int slitMax;
int slitMaxInd = 0 ;
// largest slit sum
int slitMinInd = 0 ;
// smallest slit sum
// slitSum must be long. If all pixels in a neighborhood
// were WHITE, then the slitSum = (16×16) * 255 * 8 = TOO
// BIG for 16-bit int
register ULONG slitSum;
// sum of all slits
register UINT slit;
// Compute the slits sums around the current pixel.
jm1 = i−1;
jp1 = i+1;
jm2 = i−2;
jp2 = i+2;
jm3 = i−3;
jp3 = i+3;
jm4 = i−4;
jp4 = i+4;
jm5 = i−5;
jp5 = i+5;
jm6 = i−6;
jp6 = i+6;
jm7 = i−7;
jp7 = i+7;
jm8 = 1−8;
jp8 = i+8;
slitMin =a [i] +c [i] +e [i] +g [i] +t [i] +v[i] +x[i] +z [i];
slitSum = slitMax = slitMin;
slit=a [jp2]+c [jp1] +e [jp1] +g [i] +t [i] +v [jm1] +x [jm1] +z [jm2];
SetMinMax (1) ;
slit=b [jp3] +c [jp2] +e [jp2] +g [jp1] +t [jm1] +v [jm2] +x [jm2] +y [jm
3];
SetMinMax (2) ;
slit=b [jp4] +d [jp3] +f [jp2] +g [jp1] +t [jm1] +u [jm2] +w [jm3] +y [jm
4];
SetMinMax (3) ;
slit=c [jp6] +e[jp4] +f [jp3] +h [jp1] +s [jm1] +u [jm3] +v [jm4] +x [jm
6];
SetMinMax (4) ;
slit=e [jp7] +f [jp5] +g [jp3] +h [jp2] +s [jm2] +t [jm3] +u [jm5] +v [jm
7];
SetMinMax (5) ;
slit=f [jp7] +g [jp4] +g [jp6] +h [jp2] +s [jm2] +t [jm6] +t [jm4] +u [jm
7];
SetMinMax (6) ;
slit=g [jp8] +h [jp4] +h [jp6] +r [jm2] +r [jp2] +s [jm6] +s [jm4] +t [jm
8] ;
SetMinMax (7) ;
slit=r [jm8] +r [jm6] +r [jm4] +r [jm2] +r [jp2] +r [jp4] +r [jp6] +r [jp
8];
SetMinMax (8) ;
slit=g [jm8] +h [jm6] +h [jm4]+ r [jm2] +r [jp2] +s [jp4] +s [jp6] +t [jp
8];
SetMinMax (9) ;
slit=f [jm7] +g [jm6] +g [jm4] +h [jm2] +s [jp2] +t [jp4] +t [jp6] +u [jp
7];
SetMinMax (10);
slit=e [jm7] +f [jm5] +g [jm3] +h [jm2] +s [jp2] +t [jp3] +u [jp5] +v [jp
7];
SetMinMax (11);
slit=c [jm6] +e [jm4] +f [jm3] +h [jm1] +s [jp1] +u [jp3] +v [jp4] +x [jp
6] ;
SetMinMax (12);
slit=b [jm4] +d [jm3] +f [jm2] +g [jml] +t [jp1] +u [jp2] +w [jp3] +y [jp
4] ;
SetMinMax (13);
slit=b [jm3] +c [jm2] +e [jm2] +g [jm1] +t [jp1] +v [jp2] +x [jp2] +y [jp
3];
SetMinMax (14);
slit=a [jm2] +c [jm1] +e [jm1] +g[i ] +t [i
] +v [jp1] +x [jp1] +z [jp2];
SetMinMax (15);
aSum = (UINT) ((slitSum − (ULONG) (slitMax + slitMin) ) /NS2) ;
deltaMin = aSum − slitMin;
deltaMax = slitMax − aSum;
if ( deltaMax > deltaMin )
{
peakDelta = slitMax − (int) (slitSum >> blockShift) ;
sinDirection += (info−
>sinDirectionVector [slitMaxInd] * (long)peakDelta) ;
cosDirection += (info−
>cosDirectionVector [slitMaxInd] *(long)peakDelta) ;
    }
else
{
peakDelta = (int) (slitSum >>blockShift) − slitMin;
sinDirection +=
(info−>sinDirectionVector[slitMinInd] * (long)peakDelta) ;
cosDirection +=
(info−>cosDirectionVector [slitMinInd] * (long)peakDelta) ;
}
sumDelta += (long)peakDelta;
}
}
// end of the processing on the block
if ( sumDelta == 0L )
{
sumDelta = 1L;
}
tempSumDelta = sumDelta >> MAG_SCALE_SHIFT;
if( tempSumDelta == 0L )
{
tempSumDelta = 1L;
}
tempSin = (sinDirection / tempSumDelta) ;
tempCos = (cosDirection / tempSumDelta) ;
info−>directionTheta [yb] [xb]
= compAtan (ROUND (tempCos) , ROUND (tempSin) ) >> 1;
tempSin = (sinDirection / sumDelta);
tempCos = (cosDirection / sumDelta);
// Compute the magnitude for this block.
info−>directionMagnitude [yb] [xb]
  =
(int) (0.5+sqrt (tempSin*tempSin+tempCos*tempCos) ) ;
}
}
}
```

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A fingerprint matcher comprising:
a memory configured to store reference fingerprint data; and
a controller cooperating with said memory and configured to
determine ridge flow direction magnitude values for each block of a plurality of blocks of input fingerprint data input to said controller,
iteratively identify blocks of the input fingerprint data in which the respective ridge flow direction magnitude values exceed an iteratively decremented threshold until reaching a stopping point thereby defining a final set of identified blocks of the input fingerprint data, and
determine a match between the reference fingerprint data and the final set of identified blocks of the input fingerprint data.

2. The fingerprint matcher according to claim 1 wherein said controller is configured to iteratively determine a potential stopping point value based upon a perimeter of a given set of identified blocks of the fingerprint input data and an area thereof.

3. The fingerprint matcher according to claim 2 wherein said controller is configured to determine the stopping point based upon an increase in the iteratively determined potential stopping point values.

4. The fingerprint matcher according to claim 2 wherein the given set of identified blocks of the fingerprint input data is contiguous.

5. The fingerprint matcher according to claim 2 wherein said controller is configured to iteratively determine the potential stopping point value based upon a square of the perimeter of the given set of identified blocks of the input fingerprint data divided by the area thereof.

6. The fingerprint matcher according to claim 1 wherein said controller is configured to binarize the input fingerprint data.

7. A fingerprint matcher comprising:
a memory configured to store reference fingerprint data; and
a controller cooperating with said memory and configured to
binarize input fingerprint data input to said controller,
determine ridge flow direction magnitude values for each block of a plurality of blocks of the input fingerprint data,
iteratively identify blocks of the input fingerprint data in which the respective ridge flow direction magnitude values exceed an iteratively decremented threshold until reaching a stopping point thereby defining a final set of identified blocks of the input fingerprint data and iteratively determine a potential stopping point value based upon a perimeter of a given set of identified blocks of the fingerprint input data and an area thereof, and
determine a match between the reference fingerprint data and the final set of identified blocks of the input fingerprint data.

8. The fingerprint matcher according to claim 7 wherein said controller is configured to determine the stopping point based upon an increase in the iteratively determined potential stopping point values.

9. The fingerprint matcher according to claim 7 wherein the given set of identified blocks of the fingerprint input data is contiguous.

10. The fingerprint matcher according to claim 7 wherein said controller is configured to iteratively determine the potential stopping point value based upon a square of the perimeter of the given set of identified blocks of the input fingerprint data divided by the area thereof.

11. A method of operating a fingerprint matcher comprising a memory and a controller cooperating therewith, the fingerprint matcher receiving reference fingerprint data, the method comprising:
determining ridge flow direction magnitude values for each block of a plurality of blocks of input fingerprint data input to the controller using the memory and controller;
iteratively identifying blocks of the input fingerprint data in which the respective ridge flow direction magnitude values exceed an iteratively decremented threshold until reaching a stopping point thereby defining a final set of identified blocks of the input fingerprint data using the memory and controller; and
determining a match between the reference fingerprint data and the final set of identified blocks of the input fingerprint data using the memory and controller.

12. The method according to claim 11 further comprising using the memory and controller to iteratively determine a potential stopping point value based upon a perimeter of a given set of identified blocks of the fingerprint input data and an area thereof.

13. The method according to claim 12 further comprising using the memory and controller to determine the stopping point based upon an increase in the iteratively determined potential stopping point values.

14. The method according to claim 12 wherein the given set of identified blocks of the fingerprint input data is contiguous.

15. The method according to claim 12 further comprising using the memory and controller to iteratively determine the potential stopping point value based upon a square of the perimeter of the given set of identified blocks of the input fingerprint data divided by the area thereof.

16. The method according to claim 11 further comprising using the memory and controller to binarize the input fingerprint data.
